(19) United States
(12) Patent Application Publication
(10) Pub. No.: US 2007/0146457 A1
(43) Pub. Date: Jun. 28, 2007

(54) Ink jet printer

(75) Inventor: Eiichi Kito, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 11/645,752

(22) Filed: Dec. 27, 2006

(30) Foreign Application Priority Data
Dec. 27, 2005 (JP) 2005-375311

(51) Int. Cl. B41J 2/01

(52) U.S. Cl. 347/101

(57) ABSTRACT

The inkjet printer includes a loading part of a recording medium; a print base for holding the recording medium thereon; a sucking unit for sucking the recording medium on the print base; an image recording unit for recording an image on the recording medium held on the print base by an ink jet recording method; transport units for transporting the recording medium form upstream through downstream of the image recording unit; one or both of medium type detector for determining a type of the recording medium in the loading part, and medium thickness detector for detecting a thickness of the recording medium in the loading part; and suction controller for changing suction force of the sucking unit with respect to the recording medium according to a detection result obtained by one or both of the medium type detector and the medium thickness detector.

### BACKGROUND OF THE INVENTION

The present invention relates to an ink jet printer, and more particularly, to an ink jet printer capable of stably transporting a recording medium during image recording regardless of a type of a recording medium.

Production of a print from an image recorded on a photographic film or from an image taken by a digital camera is generally performed as follows. That is, in a photographic printer for business purposes such as a so-called minilab, an image is exposed (i.e., printed) on printing paper (i.e., silver halide photosensitive material), the exposed printing paper is subjected to a wet development process including development, bleach-fixing, and washing and then the printing paper is dried and therefore the image is outputted as a print.

Such the photographic printer using printing paper requires the wet development process, so there are required a lot of labor for maintenance and the like, and there are required a lot of trouble for effluent processing. For this reason, a printer capable of outputting a print with a photographic image quality by employing an ink jet recording method has started to be used for business purposes.

In order to record a high-quality image by the ink jet printer, it is necessary to secure flatness of a recording medium and keep a distance between the recording medium and a recording head to be constant during the printing process. However, a given period of time is required to dry ink printed on the recording medium, so in a printing part and at an immediately downstream of the printing part, it should be avoided to transport the recording medium by holding a printing surface thereof with a roller or the like. For this reason, in order to maintain the flatness of the recording medium and keep the distance between the recording medium and the recording head to be constant during the printing process without bringing the printing surface of the recording medium into contact with the roller and the like provided to a transport path, adopted is a method in which the recording medium is transported while being sucked to a holding member in the printing part and at the upstream and downstream of the printing part (for example, see JP 2003-159841 A and JP 2004-216652 A).

On the other hand, for the recording medium used in an image forming apparatus such as an ink jet printer, roll paper is preferably used because of its low cost. For this reason, in the ink jet printer for business purposes, roll paper is generally used. Further, in order to facilitate a control for transportation of the recording medium, generally adopted is a method in which the recording medium is cut after printing is performed, according to sizes of images printed thereon (for example, see JP 2003-291440 A). However, in such the method, it is necessary to cut off margin portions formed between images, which leads paper loss.

Therefore, in a case of using roller paper, it is desirable to adopt a method in which the recording medium is cut according to print sizes to obtain sheets before printing.

### SUMMARY OF THE INVENTION

However, as disclosed in JP 2003-159841 A and JP 2004-216652 A, in a case of transporting the recording medium while being sucked to a holding member, there may arise various problems depending on a thickness (stiffness) of the recording medium.

When a suction force with respect to the recording medium is set to strong in order to reliably maintain the flatness of the recording medium and keep the distance between the recording medium and the recording head to be a predetermined distance, and in a case of using a thin recording medium, there arises a problem in that jamming is easily caused when the recording medium is transported because the stiffness thereof is weak. In addition, when the thin recording medium is used, irregularities and a wrinkle are easily caused in the recording medium due to suction with respect to the recording medium.

On the other hand, when the suction force with respect to the recording medium is weak, there arises no problems of jamming, a wrinkle, or the like, which is easily caused when the thin recording medium is used under the strong suction force, as described above. However, in a case of using a thick recording medium, a curl of the recording medium is difficult to be corrected, so the flatness thereof cannot be maintained and the distance between the recording head and the recording medium becomes inappropriate. As a result, it is difficult to print images appropriately. In a case of using the roll paper as the recording medium, particularly in a case of using the recording medium obtained by cutting the roller paper into sheets as described above, there arises such the problems remarkably.

Therefore, conventionally, a type of a recording medium used for each printer is determined in advance and the suction force appropriate for the recording medium is set in the each printer. Accordingly, there raises a problem of having a low degree of flexibility in performing printing, for example, in that there is a limitation of the recording medium to be used, and it is difficult to change the recording medium according to orders.

In order to solve the above-mentioned conventional technical problems, the present invention has an object to provide an ink jet printer capable of printing a high-quality image while securing flatness of a recording medium and keeping a distance between the recording medium and a recording head to be constant and capable of reliably performing printing without causing jamming, transport deficiency, a wrinkle, or the like of the recording medium, even when various types of recording media having different thicknesses, different stiffness or the like are loaded. In particular, the present invention provides an ink jet printer that effectively works as the printer having mechanisms of loading roll paper and cutting the recording medium into sheets according to the print sizes before being printed.

In order to achieve the above-mentioned object, the ink jet printer according to the present invention includes: a loading part for loading a recording medium; a print base for holding the recording medium thereon; a sucking unit for sucking the recording medium on the print base; an image recording unit for recording an image on the recording medium held on the print base by an ink jet recording method; transport units for transporting the recording medium form upstream through downstream of the image recording unit; one or both of medium type detecting means for detecting a type of the recording medium loaded in the loading part, and medium thickness detecting means for detecting a thickness of the recording medium loaded in the loading part; and suction control means for changing suction force of the sucking unit with respect to the recording medium according to a detection result obtained by one or both of the medium type detecting means and the medium thickness detecting means.

Further, the transport units transport the image recording medium intermittently and the image recording unit records the image by moving a recording head in a direction perpendicular to the transport direction of the recording medium when the transportation of the recording medium is stopped. It is preferable that the suction control means changes the suction force of the sucking unit with respect to the recording medium between a time when the recording medium is transported and a time when the transportation thereof is stopped.

In addition, the loading part is loaded with roll-type recording medium which is a wound long recording material. It is preferable that the loading part includes remaining amount detecting means for detecting a remaining amount of the roll-type recording medium, and that the suction control means changes the suction force of the sucking unit with respect to the recording medium according to a detection result of the remaining amount of the recording medium obtained by the remaining amount detecting means.

Further, it is preferable that the print base has a width for a plurality of recording media, the transport units transport the plurality of recording media in parallel, the image recording unit records images on each of the plurality of recording media aligned in parallel, and the sucking unit has independent sucking portions corresponding to each row of transportation, and that the suction control means changes the suction force of the sucking portions according to the detection result about the recording media in the each row of transportation.

According to the present invention, the suction force is appropriately adjusted by changing the suction force with respect to the recording medium in the image recording part according to the type or the like of the recording medium. Specifically, in the case of using the thin recording medium, the suction force with respect to the recording medium is lowered so as to prevent jamming, transport deficiency, a wrinkle of the recording medium, or the like from occurring, and in the case of using the thick recording medium, the suction force with respect to the recording medium is increased so as to reliably correct a curl of the recording medium to flatten the recording medium and make the distance between the recording medium and the recording head to be constant. As a result, it is possible to suitably perform printing using various kinds of recording media by a single apparatus.

### BRIEF DESCRIPTION OF THE DRAWINGS

In the accompanying drawings:

FIG. 1 is a schematic diagram showing an embodiment of an ink jet printer according to the present invention;

FIG. 2 is a block diagram showing an example of a control system of the ink jet printer shown in FIG. 1; and

FIGS. 3A to 3D are graphs each showing an example of a suction force control for the ink jet printer according to the present invention.

### DETAILED DESCRIPTION OF THE PREFERRED EMBODIMENT

Hereinafter, an ink jet printer of the present invention will be described in detail according to a preferred embodiment with reference to the attached drawings.

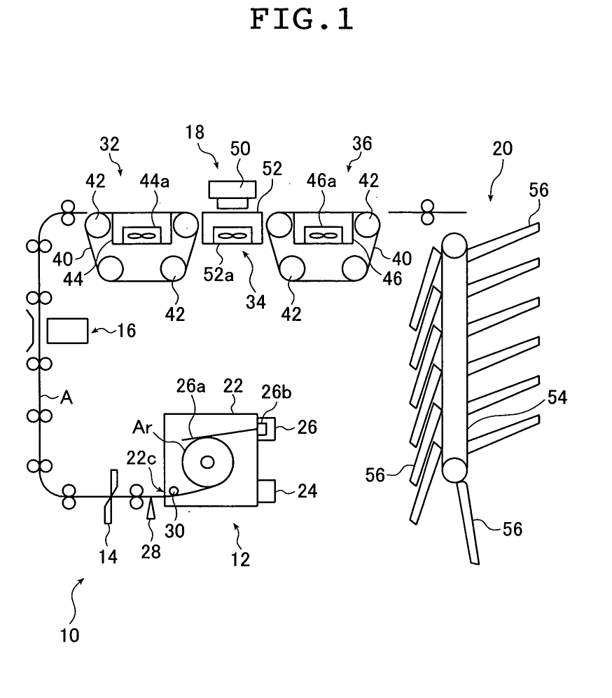

FIG. 1 is a schematic diagram showing an example of an ink jet printer according to the present invention.

In a printer 10 of the illustrated example, an image is printed on a recording sheet A (i.e., recording medium) by an ink jet recording method to be output as a print. The printer 10 includes a loading part 12, a cutter 14, a back-printing unit 16, an image recording part 18, and a discharging part 20.

In the printer 10, in addition to the illustrated members, various members included in a known printer such as a transport roller pair, a guide roller, a guide member, and a sensor for detecting a recording sheet A, or the like may be arranged as needed.

The loading part 12 is a part loaded with a magazine 22 containing a recording material Ar (hereinafter, referred to as “sheet roll Ar”) which is a long recording sheet A wound in a roll shape.

FIG. 1 shows a state where the magazine 22 is loaded in the loading part 12. The magazine 22 is a casing like a rectangular parallelpiped containing the sheet roll Ar. In the illustrated example, the sheet roll Ar is contained in the magazine 22 in a state where both ends of a winding shaft for winding the recording sheet A is axially supported in a rotatable manner.

The magazine 22 is provided with a slit-like outlet 22c for discharging the recording sheet A. In the vicinity of the outlet 22c, a guide roller 30 for guiding the recording sheet A drawn out from the sheet roll Ar is arranged.

The recording sheet A is drawn out from the sheet roll Ar, and is guided by the guide roller 30, thereby being drawn out from the outlet 22c of the magazine 22.

In addition, the loading part 12 is provided with a magazine type detecting sensor 24 (i.e., medium type detecting means) for detecting a type of the sheet roll Ar contained in the magazine 22, and a remaining amount detecting sensor 26 (i.e., remaining amount detecting means) for detecting a remaining amount of the sheet roll Ar contained in the magazine 22.

A detecting method by the magazine type detecting sensor 24 is not particularly limited, and it is possible to use any detecting means used in various printers and the like such as detecting means using a bar-code and a bar-code reader, and detecting means for detecting, by a sensor or the like, a particular protrusion which is provided to the magazine 22 for each recording sheet.

On the other hand, the remaining amount detecting sensor 26 includes an arm 26a and a remaining amount detecting part 26b including measuring means for measuring an angle of the arm 26a. One end of the arm 26a is axially supported by the remaining amount detecting part 26b in a freely swingable manner, and the arm 26a is inserted in the magazine 22 loaded in the loading part 12. Further, a vicinity of an end portion (hereinafter, referred to as “operation end”) of the arm 26a, which is an opposite end of the axially supported end portion thereof, is placed on an upper portion of the sheet roll Ar. Thus, the operation end of the arm 26a moves up and down according to the amount of the recording sheet A wound as the sheet roll Ar, that is, the angle of the arm 26a is changed according to the remaining amount of the sheet roll Ar. The remaining amount detecting part 26b detects the angle of the arm 26a to detect the remaining amount of the sheet roll Ar from the detected angle.

A method of detecting the remaining amount of the sheet roll Ar is not limited thereto, and various known means, for example, means for detecting the remaining amount of the sheet roll Ar by measuring a discharge amount of the sheet roll Ar from the magazine 22, may be adopted.

In the vicinity of the outlet 22c of the magazine 22, there is provided a thickness sensor 28 (i.e., medium thickness detecting means) for detecting a thickness of the recording sheet A drawn out from the magazine 22. The thickness detecting sensor 28 is used not for measuring the thickness of the recording sheet A but for detecting that the recording sheet A is thick or thin (or normal). A detecting method by the thickness detecting sensor 28 is not particularly limited, and any known detecting means used in various types of printers may be adopted. For example, columns [0021] and [0022] of JP 11-180597 A disclose a mechanical thickness detecting method in which a thickness of a recording sheet is detected based on a rotation angle of a rotating shaft by providing: a detection roller brought into contact with a recording sheet to be transported; an arm which has an end axially supporting the detection roller in a rotatable manner and transports movement of the detection roller in a vertical direction; a rotating shaft which converts inclination of the arm into a rotational movement at the other end of the arm; and a potentiometer which converts a rotation angle of the rotating shaft into an electrical signal. Further, column [0026] of JP 11-334054 A discloses an optical thickness detecting method in which a light emitting element and a light receiving element are provided, light emitted from the light emitting element is reflected on the recording sheet, and the angle of the light formed when the light is made incident on the light receiving element is detected, to thereby detect a thickness of a recording sheet based on the detected light angle.

In the ink jet printer according to the present invention, it is sufficient that at least one of the magazine type detecting sensor 24 and the thickness detecting sensor 28 is provided, and in a case where one of those is provided, it is preferable to provide the thickness detecting sensor 28.

The recording sheet A drawn out from the loading part 12 (specifically, magazine 22) is guided by the guide roller 30 and reaches the cutter 14. The cutter 14 is used for cutting the long sheet roll Ar into sheets according to the print sizes, and, for example, a known guillotine cutter is used as the cutter 14.

Drawing-out of the recording sheet A from the magazine 22 of the loading part 12 and the transportation of the recording sheet A are stopped when a length of the recording sheet A which reaches the downstream of the cutter 14 becomes a length corresponding to a length of the print size. Then, the cutter 14 is operated to cut the recording sheet A, thereby obtaining the recording sheets A having the print sizes.

The recording sheet A transported to the cutter 14 is further transported to the back-printing unit 16.

The back-printing unit 16 performs back print on a back surface (i.e., non-printing surface) of the recording sheet A by, for example, a dot impact printer. Alternatively, the back print may be performed by an ink jet printer or a thermal printer.

Contents of the back print are not particularly limited, and the contents thereof are, for example, various information standardized in a photographic print.

The recording sheet A on which the back print is recorded by the back-printing unit 16 is subsequently transported to the image recording part 18.

The image recording part 18 performs printing on the recording sheet A by the ink jet recording method, and includes an upstream transport part 32, a recording unit 34, and a downstream transport part 36.

The upstream transport part 32 transports the recording sheet A to the recording unit 34, and transports the recording sheet A on which an image is being printed in the recording unit 34.

On the other hand, the downstream transport part 36 transports the recording sheet A on which an image is being printed in the recording unit 34, and transports the recording sheet A (i.e., print) on which an image has been printed in the recording unit 34, to the discharging part 20.

The upstream transport part 32 and the downstream transport part 36 have the same structure.

Both the upstream transport part 32 and the downstream transport part 36 respectively include a belt conveyor constituted of an endless belt 40 having a plurality of through-holes, and four rollers 42 suspending the endless belt 40 under tension, and a support base 44 (46) which is involved in the belt conveyor (specifically, endless belt 40) and is brought into contact with an upper inner surface of the endless belt 40.

The support base 44 (46) is a hollow casing having a plurality of through-holes formed in an upper surface thereof and including sucking unit 44a (46a) using a fan arranged inside thereof. Thus, by driving the sucking unit 44a (46a), it is possible to obtain a state where the recording sheet A is sucked onto the support base 44 (46) via the endless belt 40.

The recording sheet A transported to the upstream transport part 32 and the downstream transport part 36 is transported by the belt conveyor constituted of the endless belt 40 and the rollers 42 in a state where the recording sheet A is sucked onto the endless belt 40 by a driving force of the respective sucking unit 44a and 46a.

Thus, the upstream transport part 32 can supply the recording sheet A to the recording unit 34 and transport the recording sheet A while preventing floating of the recording sheet A due to the curl or the like. Further, the downstream transport part 36 can transport the recording sheet A to the discharging part 20 without coming into contact with the printing surface of the recording sheet A after being printed while preventing the floating of the recording sheet A in the same manner as in the upstream transport part 32.

As described above, between the upstream transport part 32 and the downstream transport part 36, there is arranged the recording unit 34.

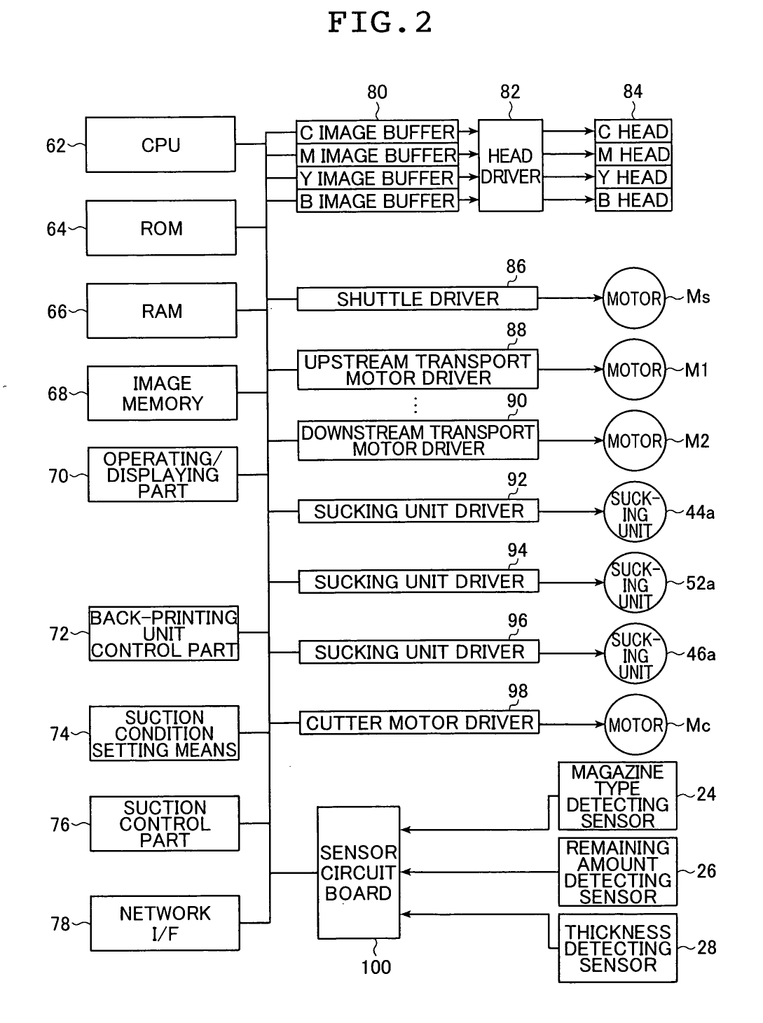

The recording unit 34 includes recording means 50 employing the known ink jet recording method with ink jet recording heads 84 (hereinafter, referred to as “recording heads 84”; see FIG. 2), and a guide base 52 (i.e., print base) for regulating a position of the recording sheet A in the vertical direction, and performs the printing of a full-color image employing the ink jet recording method.

In the illustrated example, the recording means 50 includes a carriage (i.e., scanning means) mounted with the small-size recording head 84 with nozzle arrays corresponding to the transport direction of the recording sheet A, and performs printing in which, while the recording sheet A is intermittently transported, the recording sheet A is scanned with the recording head 84 in the width direction in a state where the transportation of the recording sheet A is stopped, that is, printing employing a so-called partial width array (PWA) method using a shuttle head.

Thus, the transportation of the recording sheet A by the upstream transport part 32 and the downstream transport part 36 is intermittently performed.

The guide base 52 supports the recording sheet A from an underside thereof, and regulates the position of the recording sheet A in the vertical direction (i.e., discharging direction of ink droplets) to obtain a predetermined position (predetermined distance between the recording head 84 and the recording sheet A).

Here, the guide base 52 is also a hollow casing having a plurality of through-holes formed in the upper surface thereof, and includes the sucking unit 52a (sucking means) using a fan, arranged inside thereof. Thus, the guide base 52 can also regulate the position of the recording sheet A to the predetermined position in the state where the recording sheet A is sucked, while preventing the floating of the recording sheet A due to the curl or the like.

Further, the guide base 52 may include a groove-like ink receiver formed according to the width of the corresponding recording sheet A in order to prevent pollution of ink caused in producing a so-called borderless print in which an image is printed on edge portions of the print.

The suction force of the sucking unit 52a is controlled by an suction control part (not shown) based on the detection results obtained by the magazine type detecting sensor 24, the thickness detecting sensor 28, the remaining amount detecting sensor 26, and the like. A method of controlling the suction force will be described later.

A method of changing the suction force is not particularly limited, and it is possible to employ any known method such as a method of changing a rotational speed of the fan of the sucking unit 52a.

On the other hand, the sucking unit 44a and 46a are operated to deliver the uniformly predetermined suction force, and are not particularly controlled by the suction control part.

Further, the sucking method for the sucking unit 44a, 46a, and 52a is not limited to the suction by the fan, and it is possible to employ various methods such as a method using static electricity.

The recording sheet A (i.e., print) on which an image is printed is transported to the discharging part 20 by the downstream transport part 36. On an upper part of the downstream transport part 36 or between the downstream transport part 36 and the discharging part 20, there may be provided ink drying means such as a heater and a fan.

The discharging part 20 is a known sorter including an endless belt 54, and a plurality of bins 56 held in the rotational direction of the endless belt 54. The discharging part 20 rotates the endless belt 54 at a predetermined amount every time prints for one order are discharged, and switches the bins 56, thereby sorting the prints for each order and accumulating the prints.

FIG. 2 is a block diagram of a control system of the printer 10.

A control system of the printer 10 is configured, for example, by including: a CPU 62 for controlling and managing the entire operation of the printer 10; a ROM 64; a RAM 66; an image memory 68 for temporarily storing images; an operating/displaying part 70; a back-printing unit control part 72 for controlling the back-printing unit 16; suction condition setting means 74; an suction control part 76 (i.e., suction control means); a network interface (I/F) 78 connected to an external network; image buffers 80 (a C image buffer, an M image buffer, a Y image buffer, and a B image buffer) for temporarily storing the image data received from the image memory 68 and sending the image data to a head driver 82; the head driver 82 for driving (discharging ink) the recording heads 84 (a C head, an M head, a Y head, and a B head) based on the received image data; a shuttle driver 86 for driving a motor Ms for scanning by the recording heads 84; an upstream transport motor driver 88 for driving a motor Ml of the belt conveyor of the upstream transport part 32; a downstream transport motor driver 90 for driving a motor M2 of the belt conveyor of the downstream transport part 36; an sucking unit driver 92 for driving the sucking unit 44a; an sucking unit driver 94 for driving the sucking unit 52a; an sucking unit driver 96 for driving the sucking unit 46a; a cutter motor driver 98 for driving a motor Mc of the cutter 14; and a sensor circuit board 100 for receiving the detection results obtained by the magazine type detecting sensor 24, the remaining amount detecting sensor 26, and the thickness detecting sensor 28 to send the detection results to the suction condition setting means 74, the CPU 62, and the like.

As described above, the magazine type detecting sensor 24 detects the type of the sheet roll Ar contained in the magazine 22. When the magazine 22 is loaded in the loading part 12, the magazine type detecting sensor 24 detects the type of the sheet roll Ar contained in the loaded magazine 22, and sends the detection result to the suction condition setting means 74.

Further, the remaining amount detecting sensor 26 detects the remaining amount of the sheet roll Ar contained in the magazine 22. While the recording sheet A is drawn out from the magazine 22 and transported in the printer 10, the remaining amount detecting sensor 26 is constantly operated to detect the remaining amount of the sheet roll Ar contained in the loaded magazine 22 and send the detection result to the suction condition setting means 74. Alternatively, the remaining amount detecting sensor 26 may detect the remaining amount of the sheet roll Ar every predetermined period of time, for example, every several seconds, and when detecting a different result from the result obtained in the previous detection, the remaining amount detecting sensor 26 may send the detection result to the suction condition setting means 74.

In addition, the thickness detecting sensor 28 detects that the recording sheet A is thick or thin. In the case where the recording sheet A reaches a set position of the thickness detecting sensor 28, the thickness detecting sensor 28 detects the thickness type of the recording sheet A and sends the detection result (i.e., thick or thin) to the suction condition setting means 74.

The suction condition setting means 74 sets a parameter for controlling the suction force of the sucking unit 52a based on the detection results received from the magazine type detecting sensor 24, the remaining amount detecting sensor 26, and the thickness detecting sensor 28.

The suction condition setting means 74 holds in advance an suction condition table indicating control parameters for the suction force of the sucking unit 52a determined according to the type of the sheet roll Ar which may be loaded in the loading part 12, thickness data (i.e., thick or thin) of the sheet roll Ar, the thickness of the recording sheet A, the remaining amount of the sheet roll Ar contained in the magazine 22, and the like. Upon reception of the detection result from the magazine type detecting sensor 24 and the like, the suction condition setting means 74 searches for the data of the sheet roll Ar corresponding to the detection result, selects the control parameter for the suction force according to the corresponding data by using the suction condition table, and sends the selected control parameter to the suction control part 76 and the like.

When the magazine type detecting sensor 24 cannot detect the type of the sheet roll Ar, the suction condition setting means 74 selects the control parameter for the suction force by using the suction condition table based on the detection result of the thickness of the recording sheet A (specifically, thick or thin) obtained by the thickness detecting sensor 28, and sends the selected control parameter to the suction control part 76 and the like.

The suction condition setting means 74 may further select the control parameter for the suction force by using the suction condition table based on the detection result of the remaining amount of the sheet roll Ar (i.e., remaining amount of a recording medium) obtained by the remaining amount detecting sensor 26, and sends the selected control parameter to the suction control part 76 and the like.

The suction control part 76 controls the operation of the sucking unit 52a (i.e., suction force of a recording medium) based on the control parameters received from the suction condition setting means 74, or, in addition to that, the driving state of each of the upstream transport part 32 and the downstream transport part 34.

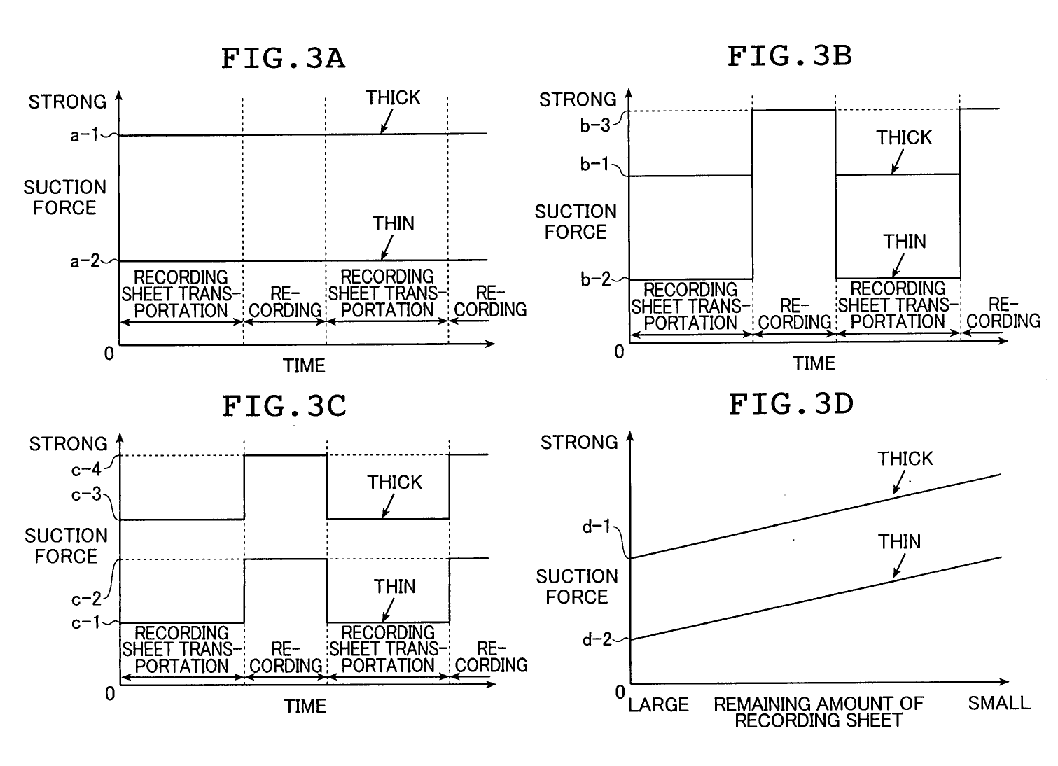

Hereinafter, a description is made as to the control for the suction force of the sucking unit 52a during the printing process (i.e., recording process) by taking four patterns A to D as examples with reference to FIG. 3A to 3D.

First, the pattern A is described. In the pattern A, as shown in FIG. 3A, the suction force of the sucking unit 52a during the printing process is changed according to the thickness of the recording sheet A.

When the magazine 22 is loaded in the loading part 12 of the printer 10, the magazine type detecting sensor 24 detects the type of the sheet roll Ar contained in the loaded magazine 22, and sends the detection result to the suction condition setting means 74. Further, in the case where the recording sheet A is drawn out from the magazine 22, the thickness detecting sensor 28 detects the thickness of the recording sheet A and sends the detection result to the suction condition setting means 74.

The suction condition setting means 74 checks the received detection result against the data of the sheet roll Ar held in advance to search for the corresponding data of the sheet roll Ar. When the corresponding data is present in the suction condition setting means 74, the suction condition setting means 74 determines that the recording sheet A wound as the sheet roll Ar contained in the magazine 22 is “thick” or “thin” based on the data. Then, using the suction condition table also held in advance, when determining that the recording sheet A is “thick”, the suction condition setting means 74 selects the control parameter for setting the suction force to a-1, which is stronger, and when determining that the recording sheet A is “thin”, the suction condition setting means 74 selects the control parameter for setting the suction force to a-2, which is weaker, from the data of the control parameter. Then, the suction condition setting means 74 sends the selected control parameter to the suction control part 76.

When the suction condition setting means 74 does not hold the corresponding data, the suction condition setting means 74 selects the control parameter based on the detection result that the recording sheet A is “thick” or “thin” received from the magazine type detecting sensor 24.

In a case where the thickness detecting sensor 28 measures the thickness (i.e., thickness represented by μm) of the recording sheet A, the suction condition setting means 74 determines that the recording sheet A is thick or thin according to the measurement result as to the thickness detected by the thickness detecting sensor 28.

The suction control part 76 controls the suction force of the sucking unit 52a based on the received control parameter. Specifically, as shown in FIG. 3A, when it is determined that the recording sheet A is “thick”, the suction control part 76 adjusts the suction force to be set to a-1 which is stronger, and when it is determined that the recording sheet A is “thin”, and adjusts the suction force to be set to a-2 which is weaker.

In this example, for example, it is determined that a recording sheet A having a thickness of 180 μm or more is “thick” and a recording sheet A having a thickness of less than 180 μm is “thin”. Further, as regards the determination of the thickness of the recording sheet A, the thickness thereof may be determined in more detail as “normal”, “very thick”, and “very thin”, in addition to “thick” and “thin”. In this regard, the same is applied to the subsequent patterns B to D.

Next, the pattern B is described. In the pattern B, as shown in FIG. 3B, the suction force of the sucking unit 52a during the printing process is changed according to the driving state of each of the upstream transport part 32 and the downstream transport part 34 as well as based on the detection results obtained by the magazine type detecting sensor 24 and the like used in the pattern A. Specifically, during the transportation of the recording sheet A, the suction force is set according to the type or thickness of the recording sheet A, and while the transportation of the recording sheet A is stopped, the suction force is set to be stronger than that set during the transportation of the recording sheet A regardless of the type or thickness of the recording sheet A.

Also in this example as in the case of the pattern A, the magazine type detecting sensor 24 and the thickness detecting sensor 28 each send the detection result to the suction condition setting means 74, and the suction condition setting means 74 determines that the thickness of the recording sheet A is “thick” or “thin” based on the received detection results.

Then, based on the determination result that the recording sheet A is “thick” or “thin”, the suction condition setting means 74 uses the suction condition table to select the control parameters in the following manner. That is, in the case where the recording sheet A is “thick”, the suction condition setting means 74 selects the control parameter for setting the suction force to b-1 which is stronger during the transportation of the recording sheet A and for setting the suction force to b-3 which is much stronger while the transportation of the recording sheet A is stopped. In the case where the recording sheet A is “thin”, the suction condition setting means 74 selects the control parameter for setting the suction force to b-2 which is weaker during the transportation of the recording sheet A and for setting the suction force to b-3 which is the same as that described above while the transportation of the recording sheet A is stopped.

After thus selecting the control parameter for the time of the transportation of the recording sheet A and for the time when the transportation thereof is stopped, the suction condition setting means 74 sends the selected control parameters to the suction control part 76.

The suction control part 76 controls the suction force of the sucking unit 52a based on the control parameters received from the suction condition setting means 74 as well as according to the driving status of each of the upstream transport part 32 and the downstream transport part 34.

Specifically, the suction control part 76 adjusts the suction force of the sucking unit 52a according to the control parameters supplied from the suction condition setting means 74 in the following manner. That is, in the case where the recording sheet A is “thick”, the suction force is set to b-1 during the transportation of the recording sheet A and the suction force is set to b-3 while the transportation of the recording sheet A is stopped. On the other hand, in the case where the recording sheet A is “thin”, the suction force is set to b-2 during the transportation of the recording sheet A and the suction force is set to b-3 while the transportation of the recording sheet A is stopped. Accordingly, in this example, while transportation of the recording sheet A is stopped, the suction force of the sucking unit 52a is made constant regardless of the thickness of the recording sheet A.

During the transportation of the recording sheet A, for example, the sucking unit 52a may be stopped in the case where the recording sheet A is “thin”, or the suction force of the recording sheet A may be set to the same suction force set while the transportation of the recording sheet A is stopped in the case where the recording sheet A is “thick”.

Next, the pattern C is described. In the pattern C, as shown in FIG. 3C, in the similar manner as in the pattern B, the suction force of the sucking unit 52a during the printing process is changed according to the driving state of each of the upstream transport part 32 and the downstream transport part 34 as well as based on the detection results obtained by the magazine type detecting sensor 24 and the like. In addition, the suction force of the sucking unit 52a for the time when the transportation of the recording sheet A is stopped, as well as the suction force thereof during the transportation, is changed according to the thickness of the recording sheet A.

Also in this example, similarly to the cases of the patterns A and B, the magazine type detecting sensor 24 and the thickness detecting sensor 28 each send the detection result to the suction condition setting means 74, and the suction condition setting means 74 determines that the recording sheet A is “thick” or “thin” based on the received detection results.

Then, based on the determination result that the recording sheet A is “thick” or “thin”, the suction condition setting means 74 uses the suction condition table to select the control parameter in the following manner. That is, in the case where the recording sheet A is “thin”, the suction condition setting means 74 selects the control parameter for setting the suction force to c-1, which is weaker, during the transportation of the recording sheet A, and for setting the suction force to c-2, which is stronger than c-1, while the transportation of the recording sheet A is stopped. In the case where the recording sheet A is “thick”, the suction condition setting means 74 selects the control parameter for setting the suction force to c-3, which is stronger than c-1, during the transportation of the recording sheet A, and for setting the suction force to c-4, which is stronger than c-3, while the transportation of the recording sheet A is stopped.

After thus selecting the control parameter for the time of the transportation of the recording sheet A and for the time when the transportation thereof is stopped, the suction condition setting means 74 sends the selected control parameter to the suction control part 76.

The suction control part 76 controls the suction force of the sucking unit 52a based on the control parameters received from the suction condition setting means 74 as well as according to the driving state of each of the upstream transport part 32 and the downstream transport part 34.

Specifically, the suction control part 76 adjusts the suction force of the sucking unit 52a according to the control parameters supplied from the suction condition setting means 74 in the following manner. That is, in the case where the recording sheet A is “thin”, the suction force is set to c-1 during the transportation of the recording sheet A and the suction force is set to c-2 while the transportation of the recording sheet A is stopped. In the case where the recording sheet A is “thick”, the suction force is set to c-3 during the transportation of the recording sheet A and the suction force is set to c-4 while the transportation of the recording sheet A is stopped. Accordingly, in this example, the suction force of the sucking unit 52a corresponds to the thickness of the recording sheet A regardless of the driving state of each of the upstream transport part 32 and the downstream transport part 34.

According to the above-mentioned patterns A to C, in the case of using the thin recording sheet A, it is possible to prevent jamming from occurring by decreasing the suction force of the sucking unit 52a at least during the transportation of the recording sheet A. Further, in the case of using the thick recording sheet A, it is possible to correct the curl or reduce the irregularities of the recording sheet A to make the recording sheet A become flatten, and reliably print images thereon by increasing the suction force of the sucking unit 52a at least while the transportation thereof is stopped. Further, according to the patterns B and C, the suction force of the sucking unit 52a is changed according to the transporting state of the recording sheet A, so it is possible to perform image printing and transportation of the recording sheet A stably and appropriately.

Next, the pattern D is described. In the pattern D, as shown in FIG. 3D, the suction force of the sucking unit 52a during the printing process is changed based on the detection result of the remaining amount of the sheet roll Ar contained in the magazine 22 obtained by the remaining amount detecting sensor 26 as well as based on the detection results obtained by the magazine type detecting sensor 24 and the like used in the patterns A to C. Specifically, when the remaining amount of the sheet roll Ar is sufficient, the suction force thereof is set to be weaker, and as the remaining amount of the sheet roll Ar becomes smaller, the suction force thereof is set to be gradually stronger.

Also in this example as in the cases of the patterns A to C, the magazine type detecting sensor 24 and the thickness detecting sensor 28 each send the detection result to the suction condition setting means 74, and the suction condition setting means 74 determines that the thickness of the recording sheet A is “thick” or “thin” based on the received detection results. Further, the remaining amount detecting sensor 26 detects the remaining amount of the sheet roll Ar contained in the magazine 22 and sends the detection results to the suction condition setting means 74.

In a case of carrying out the pattern D, as shown in FIG. 3D, set in the suction condition setting means 74 is the suction condition table in which, according to the thickness of the recording sheet A, the suction force of the sucking unit 52a is gradually increased as the remaining amount of the sheet roll Ar contained in the magazine 22 becomes small.

According to the determination result that the recording sheet A is “thick” or “thin” and the remaining amount of the sheet roll Ar contained in the magazine 22, the suction condition setting means 74 uses the suction condition table to select the control parameter for setting the suction force to d-1, which is stronger, in the case where the recording sheet A is “thick”, and selects the control parameter for setting the suction force to d-2, which is weaker, in the case where the recording sheet A is “thin”, to thereby determine the suction force of the sucking unit 52a. Then, the suction condition setting means 74 sends the control parameters indicating the suction force thereof to the suction control part 76. The suction control part 76 adjusts the suction force of the sucking unit 52a according to the supplied control parameters.

As is well known, as the remaining amount of the sheet roll Ar becomes small, the curl thereof becomes strong, so a strong force is necessary to keep the flatness thereof. While, in the pattern D, the remaining amount of the sheet roll Ar contained in the magazine 22 is detected and the suction force of the recording sheet A is increased according to the detected remaining amount of the sheet roll Ar that becomes smaller. As a result, the jamming or the wrinkle of the recording sheet A due to unnecessary strong suction can be prevented from occurring, the curl of the recording sheet A can be reliably corrected, and the printing process can be appropriately performed.

In addition, in the pattern D, the suction force of the recording sheet A may be similarly adjusted according to only the remaining amount of the sheet roll Ar contained in the magazine 22 regardless of “thick” or “thin” of the recording sheet A.

In the above-mentioned four patterns, examples of controlling only the suction force of the sucking unit 52a are illustrated, but the present invention is not limited thereto. The sucking unit 44a and/or 46a may also be controlled in the same manner. Alternatively, the suction force may be controlled by a method in which any one of the patterns A to C is combined with the pattern D.

In addition, the sucking unit 44a of the upstream transport part 32 is not necessarily provided. Alternatively, a transport roller or the like may be provided in place of the sucking unit 44a to perform the transportation of the recording sheet A.

Further, the ink jet printer according to the present invention may correspond to, for example, image recording performed by a so-called multi-row transportation in which a plurality of sheet rolls can be loaded in a direction (i.e., width direction) perpendicular to the transport direction, and a plurality of recording sheets A are aligned in the width direction to perform printing. By performing the multi-row transportation, it is possible to improve productivity.

Here, in the case where the ink jet printer corresponds to the multi-row transportation, it is preferable to make it possible to independently control the suction force for each row of transportation. Thus, even in a case where the thin recording sheet and the thick recording sheet are transported in parallel to each other to perform printing, the suction force of each recording sheet can be adjusted as indicated by the patterns A to D. Therefore, with respect to every recording sheet, the generation of jamming and formation of wrinkles or irregularities of the recording sheet are prevented, the curl of the recording sheet is reliably corrected, the flatness thereof is maintained, and the distance between the recording head and the recording sheet is appropriately set, thereby making it possible to obtain the high-quality images.

The method of independently controlling the suction force of the recording sheet A for each row of transportation is not particularly limited, and various methods can be used. For instance, exemplified are a method of providing the separate guide base 52 (or further the support base 44 and/or the support base 46, or the upstream transport part 32 and/or the downstream transport part 36) for each row of transportation, and a method of partitioning an inside of the guide base 52 (or further the support base 44 and/or the support base 46, or the upstream transport part 32 and/or the downstream transport part 36) by a wall or the like in the width direction with providing the sucking units 52a which are independently controllable for each partitioned area.

The ink jet printer according to the present invention is described in detail above, but the present invention is not particularly limited to the above-mentioned embodiment. The present invention may be modified or changed without departing from the gist of the present invention.

For example, in the above-mentioned embodiment, the sheet roll is used as the recording sheet, but the present invention is not limited thereto. The present invention may be an apparatus corresponding to a cut-sheet like recording sheet.

Further, in the above-mentioned embodiment, image recording is performed by the PWA method in which printing is performed using a shuttle head while the recording sheet is intermittently transported, but the present invention is not particularly limited thereto. Alternatively, image recording may be performed by a so-called full width array (FWA) in which a so-called line head corresponding to all the area of a recording sheet in the width direction to perform printing while the recording sheet is continuously transported.

What is claimed is:

1. An inkjet printer, comprising:
a loading part for loading a recording medium;
a print base for holding the recording medium thereon;
a sucking unit for sucking the recording medium on said print base;
an image recording unit for recording an image on the recording medium held on said print base by an ink jet recording method;
transport units for transporting the recording medium form upstream through downstream of said image recording unit;
one or both of medium type detecting means for detecting a type of the recording medium loaded in said loading part, and medium thickness detecting means for detecting a thickness of the recording medium loaded in said loading part; and
suction control means for changing suction force of said sucking unit with respect to the recording medium according to a detection result obtained by one or both of the medium type detecting means and the medium thickness detecting means.

2. The inkjet printer according to claim 1, wherein said transport units transport the image recording medium intermittently and said image recording unit records the image by moving a recording head in a direction perpendicular to the transport direction of the recording medium when the transportation of the recording medium is stopped, and
wherein said suction control means changes the suction force of said sucking unit with respect to the recording medium between a time when the recording medium is transported and a time when the transportation thereof is stopped.

3. The inkjet printer according to claim 1, wherein said loading part is loaded with roll-type recording medium which is a wound long recording material, and includes remaining amount detecting means for detecting a remaining amount of the roll-type recording medium, and
wherein said suction control means changes the suction force of said sucking unit with respect to the recording medium according to a detection result of the remaining amount of the recording medium obtained by said remaining amount detecting means.

4. The inkjet printer according to claim 1, wherein said print base has a width for a plurality of recording media, said transport units transport said plurality of recording media in parallel, said image recording unit records images on each of said plurality of recording media aligned in parallel, and said sucking unit has independent sucking portions corresponding to each row of transportation, and
wherein said suction control means changes the suction force of said sucking portions according to the detection result about the recording media in said each row of transportation.
